(19) United States
(12) Patent Application Publication
(10) Pub. No.: US 2013/0050215 A1
(43) Pub. Date: Feb. 28, 2013

(54) APPARATUS AND METHOD FOR 3D FONT ENGINE

(71) Applicants: Ruifeng XU, San Jose, CA (US); Bartley CALDER, San Jose, CA (US)

(72) Inventors: Ruifeng XU, San Jose, CA (US); Bartley CALDER, San Jose, CA (US)

(73) Assignee: SAMSUNG ELECTRONICS CO. LTD., Suwon-si (KR)

(21) Appl. No.: 13/215,759

(22) Filed: Aug. 23, 2011

(51) Int. Cl. G06T 11/00; G06T 15/10

(52) U.S. Cl. 345/427

(57) ABSTRACT

An apparatus and method for rendering two-dimensional (2D) fonts in a three-dimensional (3D) space are provided. The apparatus includes a page generation unit for obtaining font information, for generating a 3D page, and for mapping two-dimensional (2D) coordinates corresponding to control points of at least one font glyph included in the font information onto the 3D page, a 3D transformation unit for applying at least one 3D transformation to the mapped control points, a camera unit for projecting the transformed mapped control points onto a 2D plane according to camera view information, and a font rasterizer for rendering the at least one font glyphs into a bitmap or pixmap according to the projected transformed mapped control points.

### BACKGROUND OF THE INVENTION

1. Field of the Invention

The present invention relates to an apparatus and method for a generic three-dimensional (3D) font engine. More particularly, the present invention relates to an apparatus and method for rendering two-dimensional (2D) fonts in 3D space.

2. Description of the Related Art

Current font technology primarily supports rendering fonts in two dimensions, rendering fonts using x and y coordinates on a two-dimensional (2D) plane. These 2D font engines can also transform the fonts using various two dimensional transformations, including distortions, enlarging, and the like.

However, existing font engines cannot easily handle three-dimensional (3D) transformations. Typically, three techniques are employed to generate 3D transformations. In the first technique, 3D font effects are pre-applied to a 2D font. The 2D font engine merely renders the 2D fonts without performing any additional 3D transformations on them. As a result, the user cannot add any new 3D transformations; the available 3D effects for the font are limited to the previously applied 3D effects.

In the second technique, a 3D rasterizer renders the fonts as geometry or texture. While this approach allows a wider array of 3D transformations, every pixel of the font is rendered by the 3D rasterizer, which is computationally expensive in terms of time and processing power required. Due to the high computational resources required, a 3D rasterizer may not be available in many situations, especially in a mobile environment.

Finally, in the third technique, a 2D font engine supports a limited amount of 3D transformations. The 3D transformations are limited to a fixed camera view of a rotated planar surface upon which the 2D font is mapped. This technique suffers many of the deficiencies of the first technique in that the available 3D transformations are limited.

Accordingly, there is a need for an apparatus and method for providing an improved 3D font engine capable of rendering fonts in a 3D space.

### SUMMARY OF THE INVENTION

Aspects of the present invention are to address at least the above-mentioned problems and/or disadvantages and to provide at least the advantages described below. Accordingly, an aspect of the present invention is to provide an apparatus and method for rendering two-dimensional (2D) fonts in 3D space.

In accordance with an aspect of the present invention, an apparatus for rendering a font in three-dimensional (3D) space is provided. The apparatus includes a page generation unit for obtaining font information, for generating a 3D page, and for mapping two-dimensional (2D) coordinates corresponding to control points of at least one font glyph included in the font information onto the 3D page, a 3D transformation unit for applying at least one 3D transformation to the mapped control points, a camera unit for projecting the transformed mapped control points onto a 2D plane according to camera view information, and a font rasterizer for rendering the at least one font glyphs into a bitmap or pixmap according to the projected transformed mapped control points.

In accordance with another aspect of the present invention, an apparatus for rendering a font in three-dimensional (3D) space is provided. The apparatus includes an application for specifying a two-dimensional (2D) area in a 3D space, and a font engine for projecting control points of at least one font glyph onto the 2D area and for rendering the at least one font glyph according to the projected control points.

In accordance with another aspect of the present invention, a method of rendering a two-dimensional (2D) font in three-dimensional (3D) space is provided. The method includes receiving a plurality of control points corresponding to at least one glyph of a font, mapping 2D coordinates corresponding to the plurality of control points to a 3D page, applying at least one 3D transformation to the mapped control points, projecting the transformed mapped control points onto a flat planar surface based on camera view settings, and rendering the projected transformed mapped control points into a bitmap or a pixmap.

In accordance with another aspect of the present invention, a method of rendering a two-dimensional (2D) font in a three-dimensional (3D) space is provided. The method includes projecting a plurality of control points of at least one font glyph onto a predetermined 2D area defined in a 3D space, rendering the at least one font glyph based on the projected control points, and generating a bitmap or a pixmap based on the rendered font glyphs.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a diagram of a system employing a three-dimensional (3D) font engine according to an exemplary embodiment of the present invention;

FIG. 2 is a diagram of a 3D font engine according to an exemplary embodiment of the present invention;

FIG. 3 illustrates a method of rendering a two-dimensional (2D) font in a 3D space according to an exemplary embodiment of the present invention; and

FIGS. 4A-4D illustrate an example of rendering a 2D font in a 3D space according an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention are provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention include an apparatus and method for rendering two-dimensional (2D) fonts in a three-dimensional (3D) space. According to an exemplary embodiment of the present invention, a font engine is enhanced with additional functionality to support the rendering of a 2D font in a 3D space. While the fonts may be rendered using a 2D font rasterizer, the control points are transformed and projected in the 3D space prior to the rendering.

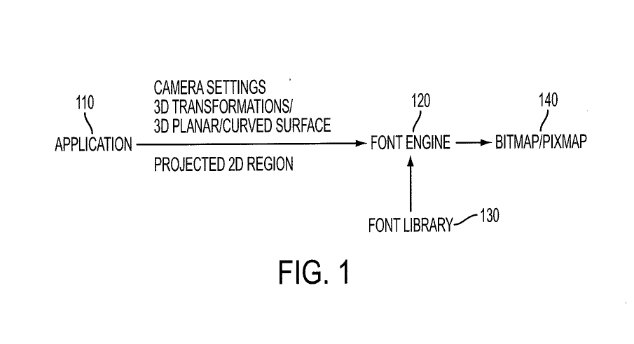

FIG. 1 is a diagram of a system employing a 3D font engine according to an exemplary embodiment of the present invention.

Referring to FIG. 1, the system includes an application 110, a font engine 120, and a font library 130. The font library may include a plurality of fonts. The plurality of fonts may be vector fonts defined according to a plurality of control points.

The application 110 may be any application making use of a 3D font. For example, a 3D font may be employed as part of a user interface in which menu options or other interface elements are displayed as if presented on a sphere, cylinder, or other 3D object. The application 110 may also employ 3D fonts outside of the user interface, such as games in which text is displayed on 3D objects within a game space, or messaging systems in which a user transmits a message employing 3D text. In a reader application, 3D text could be employed to simulate the turning of a page, in which the text on the page is printed on a sheet that curves as the page is turned. The application 110 may also be employed in other contexts, such as in text animation for generating text to be used in television or film titles.

While the exemplary embodiments described above relate to generation of 3D text for display on a screen, the application 110 may also generate 3D text to be printed onto a printable medium by a printer (not shown). The printable medium may be any medium on which text may be printed, such as paper, cardboard, transparent film, and the like. The printer may be an ink jet printer, laser printer, or other type of printer.

The font engine 120 receives the font information from the application 110 and generates the 3D font using the fonts supplied by the font library 130. The font engine 120 maps the control points onto a 3D page, performs a 3D transformation on the control points, and takes a 2D projection of the transformed control points. The font information may include the 3D transformation, the projection information, and other information used by the font engine 120 to generate the 3D fonts. The font engine 130 may output the 3D fonts as a bitmap or pixmap 140 for display or printing.

Although the mapping, transformation, and projection operations are described above as being performed by the font engine 120, these operations may also be performed by the application 110. In this case, the application 110 may supply the transformed font control points to the font engine 120 for rendering into the final 3D font.

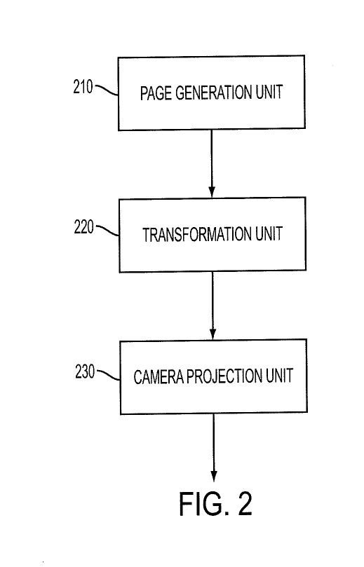

FIG. 2 is a diagram of a font engine according to an exemplary embodiment of the present invention.

Referring to FIG. 2, the font engine 120 includes a page generation unit 210, a transformation unit 220, and a camera projection unit 230. The font engine 120 may also include other components not illustrated in FIG. 2, such as a font rasterizer. Similarly, while the above units are described as part of the font engine 120, the units may also be a part of the application 110, as mentioned above.

The page generation unit 210 generates a 3D page, which will be used to determine a relative layout of font glyphs in 3D space. The 3D page may be a virtual planar (flat) surface or a virtual curved surface. The page generation unit 210 maps the control points of the font glyphs to the 3D page, thereby obtaining 3D coordinates for each control point. In addition, 2D transformations may be applied to the control points before the page generation unit 210 maps the control points to the 3D page. The information specifying the nature of the 3D page (e.g., flat, curved, etc.) may be received from the application 110, and may in turn ultimately be input to the application 110 by a user.

The transformation unit 220 applies a 3D transformation to the control points mapped to the 3D page. The transformation unit 220 may apply any 3D transformation to the control points, including mirror, shear, scale, rotation, and translation. The 3D transformation may include just one transformation or a composite of multiple 3D transformations.

The camera projection unit 230 projects the 3D coordinates of the control points to 2D coordinates according to projection properties derived from camera settings. If necessary, the camera projection unit 230 may add new control points. New control points may be added when the outline of the glyphs is highly curved, and rendering the font based on the existing control point would result in a distorted glyph. The camera settings may be provided from the application 110, or may be input by the user or automatically determined according to the application 110.

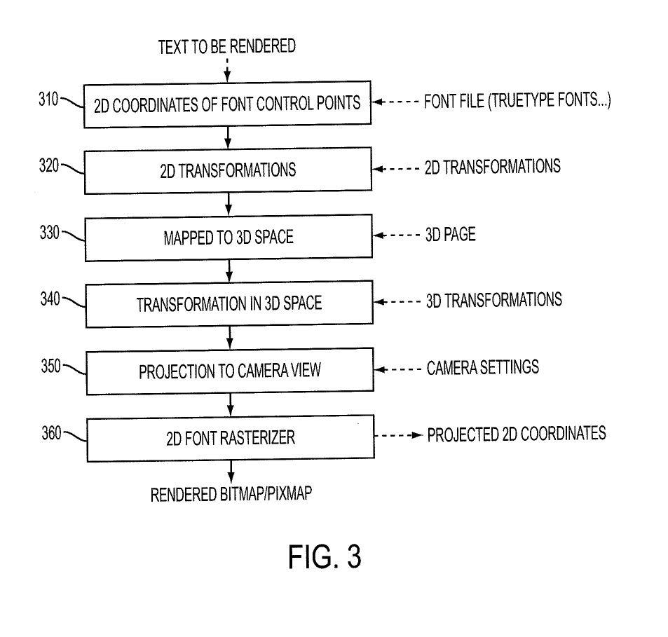

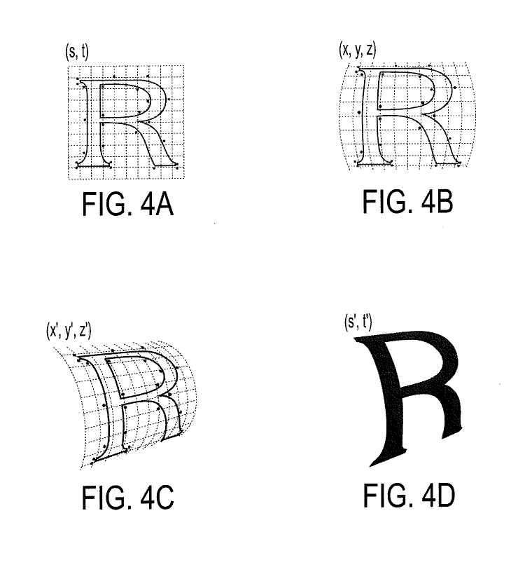

The camera projection unit 230 may be conceptualized as “taking a picture” of the control points from a particular location in 3D space. The transformed control points are projected onto the virtual film in the camera, and the resulting image is used to rasterize the fonts. The 2D coordinates of the projected control points are used by the font engine 130 to render the font glyphs as a bitmap or pixmap for output to a display or a printer. An exemplary method is described below with respect to FIGS. 3 and 4.

FIG. 3 illustrates a method of rendering a 2D font in a 3D space according to an exemplary embodiment of the present invention, and FIGS. 4A-4D illustrate an example of rendering a 2D font in a 3D space according an exemplary embodiment of the present invention.

Referring to FIG. 3 and FIGS. 4A-4D, the 2D control points of each glyph are obtained in step 310. The control points may be derived from font information contained in a font file or a font library. The fonts may be any font in which the glyphs are defined according to control points, such as TrueType, PostScript, or OpenType. The particular glyphs to be rendered are obtained based on information supplied from the application 110. FIG. 4A shows the control points mapped to 2D coordinates (s, t).

In step 320, any 2D transformations are applied to the control points. The 2D transformations may include 2D translation, 2D scaling, 2D rotation, 2D reflection, 2D shearing, and the like. The 2D transformations may be performed based on information supplied from the application 110. If no 2D transformations are specified, this step may be omitted.

In step 330, the control points are mapped to 3D coordinates on a 3D page, which is a virtual 3D surface. The 3D page may be a flat 3D surface or a curved 3D surface that is not occluded. Information defining the 3D page may be supplied from the application 110, or a default 3D page may be used if no information is provided. In FIG. 4B, the 2D coordinates (s, t) of the control points are mapped to 3D coordinates (x, y, z) of the 3D page. Any mapping function or algorithm capable of mapping 2D coordinates to 3D coordinates of a 3D surface may be employed.

In step 340, 3D transformations are applied to the mapped control points. The 3D coordinates (x, y, z) are transformed into 3D coordinates (x′, y′, z′) according to a function defined by the 3D transformation (or composite 3D transformation) to be applied. The 3D transformations may be made according to information supplied from the application 110. FIG. 4C shows a rotation transformation applied to the letter ‘R’.

In step 350, the transformed 3D coordinates of the control points are projected to a camera view. The camera view may be located at any distance or angle the 3D page. The projection transforms the 3D coordinates (x′, y′, z′) of the transformed control points back into 2D coordinates (s′, t′) based on the camera view. The parameters of the projection function may be defined by the 3D coordinates (x′, y′, z′) and the camera view settings.

In step 360, the projected 2D coordinates are fed to the font rasterizer and the final rendered bitmap or pixmap is obtained. FIG. 4D shows the final rendering of the letter ‘R’. Although the example shown in FIG. 4 involves only one glyph, exemplary embodiments of the present invention may apply the transformations to a series of glyphs (e.g., a string of text), or to one glyph at a time.

According to another exemplary embodiment of the present invention, the application 110 may specify a projected 2D area to render the font, instead of a camera view. The projected 2D area is a rectangular area in the 3D space onto which the transformed 3D coordinates are projected. The font engine 120 may apply perspective correction to map the 2D coordinates of the control points taken from the font library 130 to projected 2D coordinates on the projected 2D area.

As described above, the font engine does not need to perform any 3D rendering operations on the control points. As a result, the font engine does not require additional hardware or software libraries, and the computational requirements of the font engine are reduced. This enables the font engine to operate in devices and circumstances in which processing power may be limited, such as in mobile devices.

Devices in which exemplary embodiments of the present invention may be incorporated include any device capable of generating fonts, such as desktop computers, laptop computers, and mobile devices. Mobile devices include cellular phones, smartphones, personal digital assistants, and personal entertainment devices.

Certain aspects of the present invention can also be embodied as computer readable code on a non-transitory computer readable recording medium. A computer readable recording medium is any data storage device that can store data which can be thereafter read by a computer system. Examples of the computer readable recording medium include Read-Only Memory (ROM), Random-Access Memory (RAM), CD-ROMs, magnetic tapes, floppy disks, and optical data storage devices. Functional programs, code, and code segments for accomplishing the present invention can be easily construed by programmers skilled in the art to which the present invention pertains. However, while various components described above may be implemented as software components or as a combination of software and hardware, it would be understood that an implementation of these components may require at least some hardware in order for the components to carry out their functions.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for rendering a font in three-dimensional (3D) space, the apparatus comprising:
a page generation unit for obtaining font information, for generating a 3D page, and for mapping two-dimensional (2D) coordinates corresponding to control points of at least one font glyph included in the font information onto the 3D page;
a 3D transformation unit for applying at least one 3D transformation to the mapped control points;
a camera unit for projecting the transformed mapped control points onto a 2D plane according to camera view information; and
a font rasterizer for rendering the at least one font glyphs into a bitmap or pixmap according to the projected transformed mapped control points.

2. The apparatus of claim 1, further comprising:
an application for generating information specifying at least one of:
the font information,
the at least one 3D transformation, and
the camera view.

3. The apparatus of claim 1, further comprising:
a printer for printing the bitmap or the pixmap onto a printable medium.

4. The apparatus of claim 1, further comprising:
a display unit for displaying the bitmap or the pixmap.

5. The apparatus of claim 1, further comprising:
a font library including a plurality of fonts.

6. The apparatus of claim 1, wherein the 3D page is a planar surface.

7. The apparatus of claim 1, wherein the 3D page is a curved surface.

8. The apparatus of claim 1, wherein the page generation unit applies at least one 2D transformation to the control points, and maps the 2D transformed control points onto the 3D page.

9. An apparatus for rendering a font in three-dimensional (3D) space, the apparatus comprising:
an application for specifying a two-dimensional (2D) area in a 3D space; and
a font engine for projecting control points of at least one font glyph onto the 2D area and for rendering the at least one font glyph according to the projected control points.

10. The apparatus of claim 9, further comprising:
a printer for printing the at least one rendered font glyph onto a printable medium.

11. The apparatus of claim 9, further comprising:
a display unit for displaying the at least one rendered font glyph.

12. A method of rendering a two-dimensional (2D) font in three-dimensional (3D) space, the method comprising:
receiving a plurality of control points corresponding to at least one glyph of a font;
mapping 2D coordinates corresponding to the plurality of control points to a 3D page;
applying at least one 3D transformation to the mapped control points;
projecting the transformed mapped control points onto a flat planar surface based on camera view settings; and
rendering the projected transformed mapped control points into a bitmap or a pixmap.

13. The method of claim 12, further comprising:
printing the bitmap or the pixmap onto a printable medium.

14. The method of claim 12, further comprising:
displaying the bitmap or the pixmap on a display unit.

15. The method of claim 12, wherein the 3D page is a planar surface.

16. The method of claim 12, wherein the 3D page is a curved surface.

17. The method of claim 12, further comprising:
applying a 2D transformation onto the 2D coordinates of the control points,
wherein the mapping onto the 3D page comprises mapping the 2D transformed control points onto the 3D page.

18. A computer readable medium comprising instructions that, when read and executed by a computer, cause the computer to perform the method of claim 12.

19. A method of rendering a two-dimensional (2D) font in a three-dimensional (3D) space, the method comprising:
projecting a plurality of control points of at least one font glyph onto a predetermined 2D area defined in a 3D space;
rendering the at least one font glyph based on the projected control points; and
generating a bitmap or a pixmap based on the rendered font glyphs.

20. A computer readable medium comprising instructions that, when read and executed by a computer, cause the computer to perform the method of claim 19.
